(19) United States
(12) Patent Application Publication
(10) Pub. No.: US 2012/0026211 A1
(43) Pub. Date: Feb. 2, 2012

(54) LIQUID CRYSTAL DISPLAY APPARATUS

(75) Inventors: Ken Kikuchi, Tokyo (JP); Tomoya Yano, Kanagawa (JP)

(73) Assignee: SONY CORPORATION, Tokyo (JP)

(21) Appl. No.: 13/181,765

(22) Filed: Jul. 13, 2011

(30) Foreign Application Priority Data
Jul. 27, 2010 (JP) 2010-168579

(51) Int. Cl. G09G 5/10

(52) U.S. Cl. 345/690; 345/88

(57) ABSTRACT

A LCD display includes a light source section, a LCD panel including a plurality of pixels each having sub-pixels of R, G, B, and Z, and a display control section including an output signal generation section. The display control section performs a display drive on the sub-pixels with use of the respective output video signals, and performs a lighting drive on the light source section with use of the lighting signal. The output signal generation section generates output video signals corresponding to the respective four colors, based on the input video signals, and generates a lighting signal of the light source section, based on the input video signals, to perform a predetermined dimming processing, based on both the input video signals and the generated lighting signal, and finally generates the output video signals through performing a predetermined color conversion processing, based on a resultant video signal from the dimming processing.

### BACKGROUND

The present disclosure relates to a liquid crystal display apparatus having a sub-pixel structure made up of sub-pixels of four colors of red (R), green (G), blue (B), and white (W), for example.

In recent years, as a display for flat-screen televisions and portable terminals, an active-matrix liquid crystal display (LCD) apparatus in which TFT (Thin Film Transistor) is disposed in each pixel is often used. In such a liquid crystal display apparatus, generally, a video signal is line-sequentially written to a subsidiary capacitive device and a liquid crystal device of each pixel from the upper portion to the lower portion of the screen, thereby driving each pixel.

In the past, in order to lower power consumption of a liquid crystal display apparatus during video display, configurations in which each of pixels in a liquid crystal display panel includes sub-pixels of four colors (see Japanese Examined Patent Application Publication No. Hei 4-54207, Japanese Unexamined Patent Application Publication No. Hei 04-355722, and Japanese Patent No. 4354491, for example) have been proposed. Here, the sub-pixels of four colors include sub-pixels of three colors, red (R), green (G), blue (B), and a sub-pixel of a color higher in luminance than the three colors (Z; white (W) or yellow (Y), for example). When a video display is carried out using video signals for such sub-pixels of four colors, luminance efficiency can be enhanced in comparison with the case where a video display is carried out by supplying video signals for three colors to each pixel having a known sub-pixel structure of three colors of R, G, and B.

Meanwhile, in Japanese Patent No. 4354491, a liquid crystal display apparatus in which luminance of a back light is actively (dynamically) controlled (dimming processing is carried out) according to a video to be displayed (according to a signal level of a video signal) has been proposed. When using this method, it is possible to realize lower power consumption and expansion of dynamic range while keeping a display luminance.

### SUMMARY

Incidentally, in a liquid crystal display apparatus, a light incident on a liquid crystal layer from a back light is modulated according to the signal level of a video signal, and a light amount (luminance) of transmitted light (display light) is controlled. It is known that spectroscopic characteristic of the transmitted light from the liquid crystal layer generally shows gradation dependency, and transmittance peak shifts to the short wavelength side (blue light side) as the signal level of the video signal lowers. In the known sub-pixel structure of three colors of R, G, and B, color filters for selectively transmitting light of predetermined wavelength region is disposed in each sub-pixel. Therefore, even if a chromaticity point at the maximum signal level in each of video signals for each color is set as a reference, the above mentioned wavelength shift of transmittance peak is not a major problem.

Meanwhile, in a liquid crystal display apparatus using the above mentioned sub-pixel structure of four colors, a sub-pixel of Z shows high luminance characteristic, so that spectroscopic characteristic of transmitted light from the sub-pixel of Z largely changes according to a signal level of a video signal. Therefore, a chromaticity point of transmitted light (display light) from whole pixels also largely shifts in response to the signal level of the video signal. In particular, when a sub-pixel of W is employed as the sub-pixel of Z, since no color filter is disposed in the sub-pixel of W, variation of the chromaticity point of the display light according to the signal level is large. For example, when cell thickness and drive voltage in the sub-pixel of W is so set that a transmittance in a sub-pixel of W shows relatively high liquid crystal spectroscopic characteristic, in other words, that a transmittance peak is in the vicinity of a wavelength region of G, the result is as follows. That is, at a signal level lower than the maximum signal level in the sub-pixel of W, a transmittance peak is located in the wavelength region of B.

As described, when a variation of a transmittance peak occurs in a sub-pixel of W according to a signal level, the liquid crystal display apparatus having the sub-pixel structure of four colors of R, G, B, and Z shows a nonlinearity as follows. Specifically, the nonlinearity is shown in a relationship between a signal level of a Z-sub-pixel video signal (Z signal), and, in the case where the signal level of the Z-sub-pixel video signal is replaced by a set of R-, G-, and B-sub-pixel intermediate video signals.

If the above mentioned active control (dimming processing) of the back light luminance is carried out in the case where just-mentioned nonlinearity is shown, in some cases, a signal level of a video signal also nonlinearly changes to cause a variation (color shift) of a chromaticity point, thereby lowering image quality. In addition, in order to suppress the lowering in image quality due to the color shift, a complicate arithmetic processing for the nonlinearity becomes necessary upon signal processing, which leads to a complicate device configuration.

For the reasons described above, in the known liquid crystal display apparatus, when carrying out a video display using a sub-pixel structure of four colors of R, G, B, and Z, it is difficult to realize a dimming process, by a simple configuration, while at the same time reducing the lowering in image quality due to color shift, and therefore there is a need for a method for improvement.

The present disclosure has been made in view of the above circumstances and provides a liquid crystal display apparatus which can realize, in a simple configuration, a dimming processing while suppressing a lowering of image quality due to color shift in the case of performing a video display using a sub-pixel structure of four colors of R, G, B, and Z.

A liquid crystal display apparatus according to an embodiment of the disclosure includes: a light source section; a liquid crystal display panel including a plurality of pixels each of which having sub-pixels of three colors of red (R), green (G), and blue (B), and a sub-pixel of a color (Z) showing luminance higher than those of the three colors, the liquid crystal display panel being configured to modulate light emitted from the light source section, based on input video signals corresponding to the respective three colors of R, G, and B to perform a video display; and a display control section including an output signal generation section adapted to generate, based on the input video signals, output video signals corresponding to the respective four colors of R, G, B, and Z, and to generate a lighting signal of the light source section, the display control section being configured to perform a display drive on the sub-pixels of R, G, B, and Z in the liquid crystal display panel with use of the respective output video signals, and perform a lighting drive on the light source section with use of the lighting signal. The output signal generation section generates the lighting signal, based on the input video signals, to carry out a predetermined dimming processing, based on both the input video signals and the generated lighting signal, and the output signal generation section generates the output video signals through carrying out, based on a resultant video signal from the dimming processing, a predetermined color conversion processing.

In the liquid crystal display apparatus of the present disclosure, output video signals corresponding to respective four colors of R, G, B, and Z and a lighting signal of the light source section are generated based on input video signals corresponding to respective three colors of R, G, and B, a display drive of each of the sub-pixels of R, G, B, and Z is carried out with use of the output video signals, and a lighting drive on the light source section is carried out with use of the lighting signal. In this case, the lighting signal is generated based on the input video signals, and a predetermined dimming processing is carried out based on both the input video signals and the lighting signal, and thereafter, a predetermined color conversion processing based on a resultant video signal from the dimming processing is carried out, to thereby generate the output video signals. In other words, the generation and the dimming processing of the lighting signal are carried out to the input video signals which correspond to the three colors of R, G, and B, and thereafter, a color conversion processing is carried out to generate the output video signals which correspond to four colors of R, G, B, and Z. By this procedure, as opposed to the case where the generation and the dimming processing of the lighting signal are carried out after the video signals R, G, B, and Z are generated by the color conversion processing, the color shift of the display light due to variation of peak wavelength region in irradiating light from the sub-pixel of Z (nonlinearity in a relationship between a signal level of a Z-sub-pixel video signal (Z signal), and a signal level of each of R-, G-, B-sub-pixel intermediate video signals in the case where the signal level of the Z-sub-pixel video signal is replaced by a set of the R-, G-, and B-sub-pixel video signals) is suppressed with a simple arithmetic processing (dimming processing).

According to the liquid crystal display apparatus of the present disclosure, the lighting signal is generated based on the input video signals corresponding to respective three colors of R, G, and B, and a predetermined dimming processing is carried out based on the input video signals and the lighting signal, and thereafter, a predetermined color conversion processing is carried out based on a resultant video signal from the dimming processing, to thereby generate the output video signals corresponding to respective four colors of R, G, B, and Z, so that it is possible to reduce the color shift of the display light due to the nonlinearity with a simple arithmetic processing (dimming processing). Therefore, when a video display is carried out using a sub-pixel structure of four colors of R, G, B, and Z, it is possible to realize a dimming processing while lowering of image quality due to color shift is suppressed with a simple configuration.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating a general configuration of a liquid crystal display apparatus according to an embodiment of the present disclosure.

FIGS. 2A and 2B are schematic plan views illustrating exemplary sub-pixel structures of the pixel shown in FIG. 1.

FIG. 3 is a circuit diagram illustrating a specific configuration example of the sub-pixels shown in FIGS. 2A and 2B.

FIG. 4 is a block diagram illustrating a specific configuration of an output signal generation section shown in FIG. 1.

FIG. 5 is a block diagram illustrating a specific configuration of an RGB/RGBW conversion section shown in FIG. 4.

FIGS. 6A and 6B are characteristic charts for describing an example of a limiting processing of a signal level when the RGB/RGBW conversion is carried out.

FIG. 7 is a characteristic chart illustrating an example of wavelength dependency of spectral transmittance according to a signal level of W signal according to a comparative example.

FIG. 8 is a characteristic chart illustrating an example of wavelength dependency of spectral transmittance in each sub-pixel of R, G, B, and W according to the comparative example.

FIG. 9 is a characteristic chart illustrating an example of ideal color reproduction characteristic in an RGBW sub-pixel structure in HSV color space.

FIG. 10 is a characteristic chart illustrating an example of color reproduction characteristic in the RGBW sub-pixel structure according to the comparative example in HSV color space.

FIG. 11 is a characteristic chart illustrating an example of a relationship between a signal level of the W signal and signal levels of R, G, and B in the case where the signal level of W is replaced by a set of R-, G-, and B-sub-pixel intermediate video signal in the RGBW sub-pixel structure according to the comparative example.

FIGS. 12A and 12B are characteristic charts illustrating an example of a common LUT which is used in a BL level calculation section according to a modification 1.

FIG. 13 is a block diagram illustrating a specific configuration example of a BL level calculation section according to a modification 2.

FIG. 14 is a characteristic chart illustrating an example of a LUT for R which is used in the BL level calculation section shown in FIG. 13.

FIG. 15 is a characteristic chart illustrating an example of a LUT for G which is used in the BL level calculation section shown in FIG. 13.

FIG. 16 is a characteristic chart illustrating an example of a LUT for B which is used in the BL level calculation section shown in FIG. 13.

FIGS. 17A and 17B are characteristic charts illustrating another example of a LUT for R which is used in the BL level calculation section shown in FIG. 13.

FIGS. 18A and 18B are characteristic charts illustrating another example of a LUT for G which is used in the BL level calculation section shown in FIG. 13.

FIGS. 19A and 19B are characteristic chart illustrating another example of a LUT for B which is used in the BL level calculation section shown in FIG. 13.

FIGS. 20A and 20B are schematic plan views illustrating exemplary sub-pixel structures of a pixel according to a modification 3.

### DETAILED DESCRIPTION OF THE PREFERRED EMBODIMENTS

Hereinafter, an embodiment of the present disclosure will be specifically described with reference to the drawings. The description will be made in the following order.

1. Embodiment (example of liquid crystal display apparatus using RGBW panel)

### 2. Modification

Modification 1 (example in which common LUT is used between R, G, and B in BL level calculation section)

Modification 2 (example in which individual LUTs are used for each of R, G, and B in BL level calculation section)

Modification 3 (example of liquid crystal display apparatus using RGBZ panel)

### Embodiment

### General Configuration of Liquid Crystal Display Apparatus 1

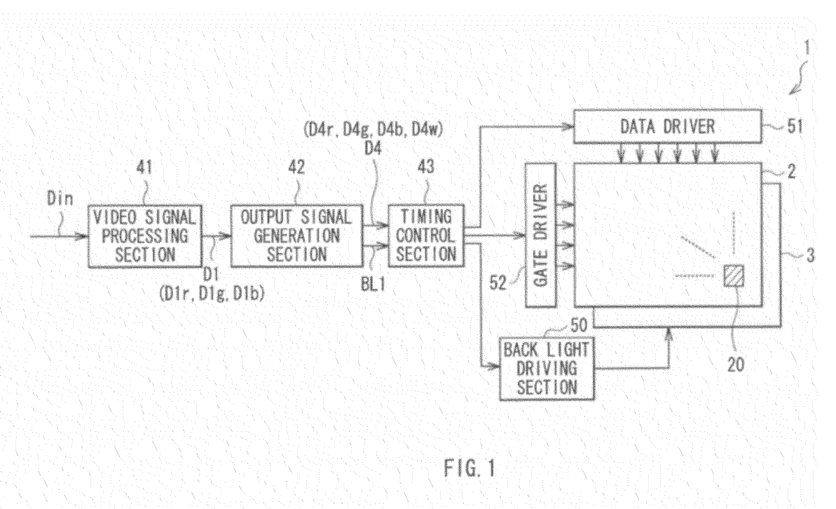

FIG. 1 is a block diagram illustrating a general configuration of a liquid crystal display apparatus 1 according to an embodiment of the present disclosure.

The liquid crystal display apparatus 1 carries out a video display based on an input video signal Din which is externally input. The liquid crystal display apparatus 1 includes a liquid crystal display panel 2, a back light 3 (light source section), a video signal processing section 41, an output signal generation section 42, a timing control section 43, a back light driving section 50, a data driver 51, and a gate driver 52. Among them, the video signal processing section 41, the output signal generation section 42, the timing control section 43, the back light driving section 50, the data driver 51, and the gate driver 52 correspond to a specific example of “a display control section” of the present disclosure.

The liquid crystal display panel 2 modulates light emitted from the back light 3 (described later) based on an input video signal Din to carry out a video display based on the input video signal Din. The liquid crystal display panel 2 includes a plurality of pixels 20 arranged in a matrix as a whole.

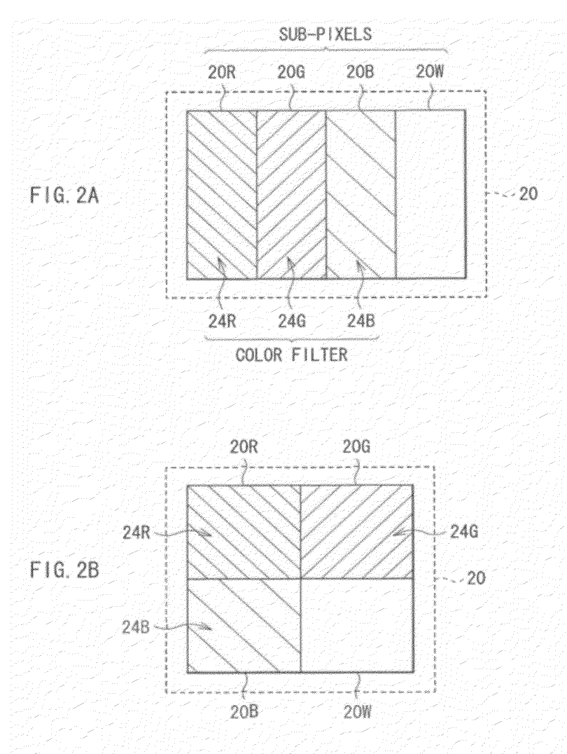

FIGS. 2A and 2B are schematic plan views each illustrating an exemplary sub-pixel structure in each pixel 20. Each pixel 20 has, a sub-pixel 20R corresponding to red (R), a sub-pixel 20G corresponding to green (G), a sub-pixel 20B corresponding to blue (B), and a sub-pixel 20W corresponding to white (W) which is higher in luminance than these three colors. Of these sub-pixels 20R, 20G, 20B, and 20W of four colors of R, G, B, and W, the sub-pixels 20R, 20G, and 20B respectively corresponding to three colors of R, G, and B have color filters 24R, 24G, and 24B respectively corresponding to colors of R, G, and B. In other words, the color filter 24R corresponding to R is disposed to the sub-pixel 20R corresponding to R, the color filter 24G corresponding to G is disposed to the sub-pixel 20G corresponding to G, the color filter 24B corresponding to B is disposed to the sub-pixel 20B corresponding to B. On the other hand, no color filter is disposed to the sub-pixel 20W corresponding to W.

Here, in the example shown in FIG. 2A, in the pixel 20, four sub-pixels of 20R, 20G, 20B, and 20W are disposed in a line in this order (along horizontal direction (H), for example). On the other hand, in the example shown in FIG. 2B, in the pixel 20, four sub-pixels of 20R, 20G, 20B, and 20W are disposed in matrix of 2 rows×2 columns. It is to be noted that the arrangement of four sub-pixels 20R, 20G, 20B, and 20W in the pixel 20 is not limited to these examples and other arrangement may be adopted.

Due to the sub-pixel structure of four colors, in the pixel 20 of the embodiment, luminance efficiency of video display can be enhanced compared with the case of the sub-pixel structure of three colors of R, G, and B. Details will be described later.

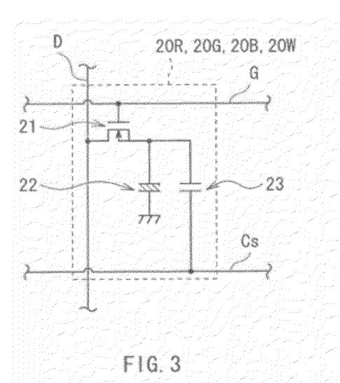

FIG. 3 illustrates an exemplary circuit configuration of a pixel circuit in each of the sub-pixels 20R, 20G, 20B, and 20W. Each of the sub-pixels 20R, 20G, 20B, and 20W has a liquid crystal device 22, a TFT device 21, and a subsidiary capacitive device 23. To each of the sub-pixel 20R, 20G, 20B, and 20W, a gate line G for line-sequentially selecting a pixel to be driven, a data line D for supplying to a pixel to be driven a video voltage (a video voltage supplied from the data driver 51 described later), and a subsidiary capacitive line Cs are connected.

The liquid crystal device 22 carries out a display operation according to a video voltage supplied to one end thereof from the data line D through the TFT device 21. The liquid crystal device 22 is a device in which a liquid crystal layer (not shown) made up of a liquid crystal such as VA (Vertical Alignment) mode liquid crystal or TN (Twisted Nematic) mode liquid crystal is sandwiched between a pair of electrodes (not shown). One of, or one end of, the pair of electrodes in the liquid crystal device 22 is connected to a drain of the TFT device 21 and one end of the subsidiary capacitive device 23, the other of, or the other end of, the pair of electrodes is grounded. The subsidiary capacitive device 23 is a capacitive device for stabilizing an accumulated charge of the liquid crystal device 22. One end of the subsidiary capacitive device 23 is connected to one end of the liquid crystal device 22 and the drain of the TFT device 21, and the other end is connected to the subsidiary capacitive line Cs. The TFT device 21 is a switching device for supplying, to both of one end of the liquid crystal device 22 and one end of the subsidiary capacitive device 23, a video voltage based on a video signal D1, and is a MOS-FET (Metal Oxide Semiconductor-Field Effect Transistor). A gate and a source of the TFT device 21 are connected to the gate line G and the data line D, respectively, and the drain of the TFT device 21 is connected to both of one end of the liquid crystal device 22 and one end of the subsidiary capacitive device 23.

The back light 3 is a light source section for irradiating light to the liquid crystal display panel 2, and is made up of, for example, Cold Cathode Fluorescent Lamp (CCFL), Light Emitting Diode (LED), or the like as a light emitting device. The back light 3 carries out a lighting drive (active control or dynamic control of luminance) according to a luminance level or signal level of an input video signal Din, and the detail will be described later.

The video signal processing section 41 carries out, for example, a predetermined image processing (e.g., sharpness processing, gamma correction, or the like) for improving image quality on an input video signal Din of the pixel signal corresponding to three primary colors of R, G, and B. By this, a video signal D1 of the pixel signal corresponding to three colors of R, G, and B (that is, a pixel signal D1r for R, a pixel signal D1g for G, and a pixel signal D1b for B) is generated.

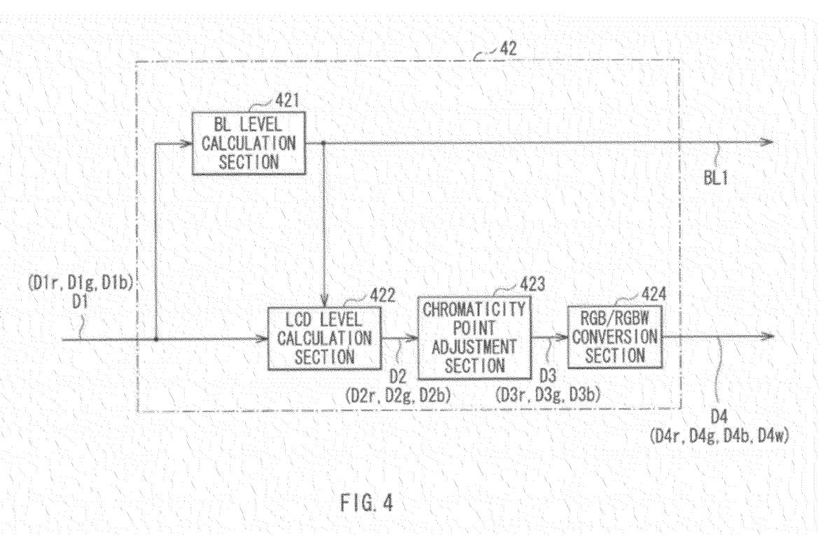

The output signal generation section 42 carries out a predetermined signal processing described later based on a video signal D1 (D1r, D1g, and D1b) supplied from the video signal processing section 41. By this, a lighting signal BL1 which shows luminance level (lighting level) in the back light 3, and a video signal D4 (pixel signal D4r for R, pixel signal D4g for G, pixel signal D4b for B, and pixel signal D4w for W) or an output video signal are generated. In this case, in the embodiment, the lighting signal BL1 is generated based on the video signal D1, and a predetermined dimming processing described later is carried out based on the video signal D1 and the generated lighting signal BL1. Then, a predetermined color conversion processing described later is carried out based on the resultant video signal from the dimming processing (video signal D2 described later), thereby generating a video signal D4. It is to be noted that, specific configuration of the output signal generation section 42 will be described later (FIG. 4 to FIG. 6B).

The timing control section 43 controls the drive timing of the back light driving section 50, the gate driver 52, and the data driver 51, and supplies a video signal D4 supplied from the output signal generation section 42 to the data driver 51.

According to the timing control by the timing control section 43, the gate driver 52 line-sequentially drives each of the pixels 20 (each of sub-pixels 20R, 20G, 20B, and 20W) in the liquid crystal display panel 2 along the gate line G. On the other hand, the data driver 51 supplies the video voltage based on the video signal D4 supplied from the timing control section 43 to each of the pixels 20 (each of the sub-pixels 20R, 20G, 20B, and 20W) of the liquid crystal display panel 2. In other words, the data driver 51 supplies the pixel signal D4r for R to the sub-pixel 20R, supplies the pixel signal D4g for G to the sub-pixel 20G, supplies the pixel signal D4b for B to the sub-pixel 20B, and supplies the pixel signal D4w for W to the sub-pixel 20W. More specifically, the data driver 51 converts the video signal D4 from digital to analog (D/A) to generate a video signal (above mentioned video voltage) as an analog signal, and outputs the resulting signal to each of the pixels 20 (each of the sub-pixels 20R, 20G, 20B, and 20W). In this manner, the display drive of each of the pixels 20 (each of the sub-pixels 20R, 20G, 20B, and 20W) in the liquid crystal display panel 2 based on the video signal D4 is carried out.

According to the timing control performed by the timing control section 43, the back light driving section 50 carries out a lighting drive (lighting drive) of the back light 3 based on the lighting signal BL1 output from the output signal generation section 42. Specifically, a lighting drive (active control or dynamic control of luminance) according to the luminance level or signal level of the input video signal Din is carried out, and the detail will be described later.

### [Specific Configuration of Output Signal Generation Section 42]

Next, with reference to FIG. 4 to FIG. 6B, a specific configuration of the output signal generation section 42 will be described. FIG. 4 illustrates a block configuration of the output signal generation section 42. The output signal generation section 42 has a BL level calculation section 421, an LCD level calculation section 422, a chromaticity point adjustment section 423, and an RGB/RGBW conversion section 424.

The BL level calculation section 421 generates a lighting signal BL1 in the back light 3 based on a video signal D1 (D1r, D1g, and D1b). Specifically, the BL level calculation section 421 analyses a luminance level (signal level) of the video signal D1 to obtain a lighting signal BL1 corresponding to the luminance level. Specifics of the generating operation for the lighting signal BL1 in the BL level calculation section 421 will be described later.

Based on the video signal D1 (D1r, D1g, and D1b) and the lighting signal BL1 output from the BL level calculation section 421, the LCD level calculation section 422 generates a video signal D2 (pixel signal D2r for R, pixel signal D2g for G, and pixel signal D2b for B). Specifically, the LCD level calculation section 422 carries out a predetermined dimming processing (here, the signal level of the video signal D1 is divided by the signal level of the lighting signal BL1) based on the video signal D1 and the lighting signal BL1 to generate the video signal D2. To be more precise, the LCD level calculation section 422 generates the video signal D2 with use of the following expressions (1) to (3).

D2r=(D1r/BL1) (1)

D2g=(D1g/BL1) (2)

D2b=(D1b/BL1) (3)

The chromaticity point adjustment section 423 carries out a predetermined chromaticity point adjustment of a video signal D2 (D2r, D2g, and D2b) to generate a video signal D3 (D3r, D3g, and D3b). Specifically, when a video signal D2 (D1) is a video signal indicating white (W), the chromaticity point adjustment is carried out so that a chromaticity point of display light emitted from the liquid crystal display panel 2 based on emitted light from the back light 3 is white chromaticity point. Incidentally, “when a video signal D2 (D1) is a video signal indicating white (W)” corresponds to the case when a luminance level (signal level or luminance gradation) of each of the pixel signals D2r, D2g, and D2b (D1r, D1g, and D1b) is at the maximum value.

In this case, the chromaticity point adjustment section 423 carries out a chromaticity point adjustment with use of, for example, a transformation matrix M_{d2} d3 specified by the following expression (4). In other words, the video signal D2 (pixel signals D2r, D2g, and D2b) is multiplied by the transformation matrix M_{d2}→_{d3}, in other words, a matrix operation is carried out, thereby generating the video signal D3 (pixel signals D3r, D3g, and D3b). Here, as shown in expression (4), the transformation matrix M_{d2}→_{d3} can be obtained by multiplying the transformation matrix M_{d2}→_{XYZ} by the transformation matrix M_{XYZ}→_{d3} (matrix operation). The transformation matrix M_{d2}→_{XYZ} is a transformation matrix from the video signal D2 to the tristimulus values (X, Y, Z) in the white color chromaticity point. On the other hand, the transformation matrix M_{XYZ}→_{d3} is a transformation matrix from this tristimulus values (X, Y, Z) to the video signal D3, and can be obtained with use of the following expression (5). In this expression (5), (Xw, Yw, Zw) represent tristimulus values in the sub-pixel 20W, and (Wr, Wg, Wb) represent the signal level of each sub-pixel intermediate video signal in the case where the signal level of the video signal (W signal) for the sub-pixel 20W is replaced by a set of the intermediate video signals for each of the sub-pixels 20R, 20G, and 20B.

$$\begin{matrix}[ Expression 1 ] & \\ {M}_{d 2 -> d 3} = ( {M}_{d 2 -> XYZ} ) \times ( {M}_{XYZ -> d 3} ) & ( 4 ) \\ ( \begin{matrix}{W}_{r} \\ {W}_{g} \\ {W}_{b}\end{matrix} ) = {M}_{XYZ} -> {d}_{3} ( \begin{matrix}{X}_{w} \\ {Y}_{w} \\ {Z}_{w}\end{matrix} ) & ( 5 )\end{matrix}$$

### [A: RGB/RGBW Conversion Section 424]

The RGB/RGBW conversion section 424 carries out a predetermined RGB/RGBW conversion processing (color conversion processing) on the video signal D3 (D3r, D3g, and D3b) which corresponds to the three colors of R, G, and B and is output from the chromaticity point adjustment section 423. Thus, a video signal D4 (D4r, D4g, D4b, and D4w) corresponding to four colors of R, G, B, and W is generated.

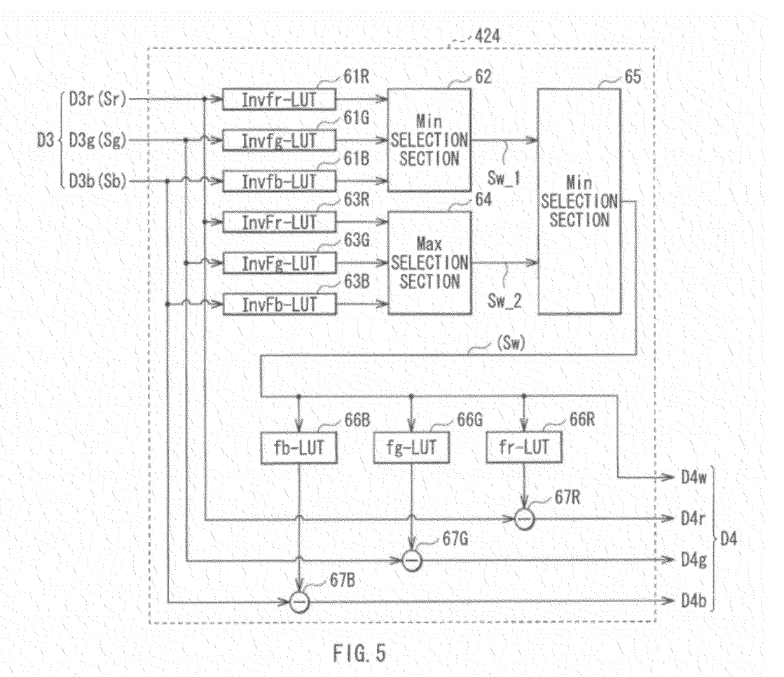

FIG. 5 illustrates a block configuration of the RGB/RGBW conversion section 424. The RGB/RGBW conversion section 424 has LUTs (Look-Up Tables) 61R, 61G, and 61B for each color of R, G, and B; a Min selection section 62; LUTs 63R, 63G, and 63B for each color of R, G, and B; a Max selection section 64; a Min selection section 65; LUTs 66R, 66G, and 66B for each color of R, G, and B; and subtraction sections 67R, 67G, and 67B.

It is to be noted that, here, the pixel signals D3r, D3g, and D3b, which are input signals, are described as Sr, Sg, and Sb, respectively. In addition, the LUTs 61R, 61G, and 61B are LUTs which respectively correspond to inverse functions invfr, invfg, and invfb described later. Therefore, in the figure, the LUTs 61R, 61G, and 61B are respectively shown as “Invfr-LUT”, “Invfg-LUT”, and “Invfb-LUT”. Likewise, the LUTs 63R, 63G, and 63B are LUTs which respectively correspond to inverse functions invFr, invFg, and invFb described later. Therefore, in the figure, the LUTs 63R, 63G, and 63B are respectively shown as “InvFr-LUT”, “InvFg-LUT”, and “InvFb-LUT”. Further, LUTs 66R, 66G, and 66B are LUTs which respectively correspond to functions fr, fg, and fb described later. Therefore, in the figure, the LUTs 66R, 66G, and 66B are respectively shown as fr-LUT, fg-LUT, and fb-LUT.

### [Expression for Computation in Conversion Process]

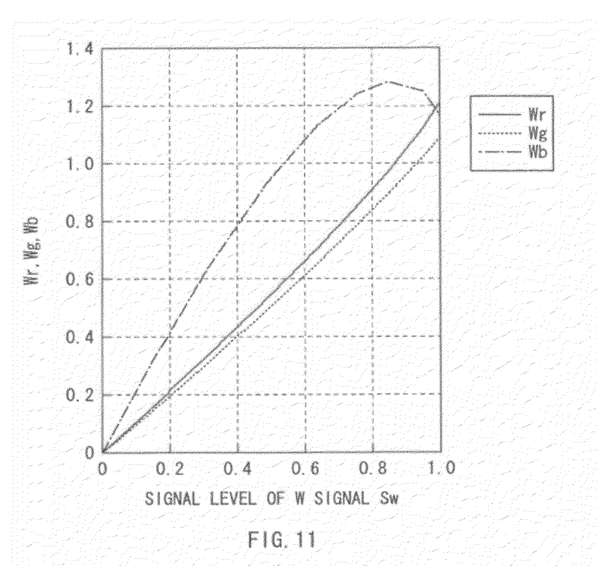

Firstly, in the RGB/RGBW conversion processing, Look-Up Tables (LUTs) representing which set of signal levels can realize the process, when a signal level of a video signal D4w (Sw) for a sub-pixel 20W is replaced by a set of the intermediate video signals for sub-pixels 20R, 20G, and 20B (which correspond to above-mentioned Wr, Wg, and Wb, respectively), is used. In other words, LUTs 66R, 66G, and 66B (first LUT) which are LUTs prepared according to nonlinearity (nonlinearity in a relationship between a signal level of Sw and signal levels of Wr, Wg, and Wb) to be described later and shown in FIG. 11, are used.

Here, if functions corresponding to the LUTs 66R, 66G, and 66B are respectively denoted by fr (Sw), fg (Sw), and fb (Sw), then the RGB/RGBW conversion in the RGB/RGBW conversion section 424 can be expressed by the following formula (6). It is to be noted that, signal levels of pixel signals D4r (=Sr−fr (Sw)), D4g (=Sg−fg (Sw)), D4b (=Sb−fb (Sw)), and D4w (=Sw) after the RGB/RGBW conversion have to be a positive value. For this reason, it is necessary to satisfy the following conditional expressions (7) to (9).

[Expression 2]

(Sᵣ,S_{g},S_{b})→(Sᵣ−fᵣ(S_{w}),S_{g}−f_{g}(S_{w}),Sb−fb(S_{w}),S_{w}) (6)

Sᵣ→fᵣ(S_{w}) (7)

S_{g}→f_{g}(S_{w}) (8)

S_{b}→f_{b}(S_{w}). (9)

In order to satisfy the conditional expressions (7) to (9), inverse functions invfr (Sr), invfg (Sg), and invfb (Sb) respectively corresponding to the functions fr (Sw), fg (Sw), and fb (Sw) are used. In other words, LUTs 61R, 61G, and 61B respectively corresponding to the inverse function invfr (Sr), invfg (Sg), and invfb (Sb) are provided. In each of the LUTs 61R, 61G, and 61B, when signal levels of inputs (Sr, Sg, and Sb) exceed the maximum value of each color in the vertical axis in the graph shown in FIG. 11, the maximum value of Sw (=1.0) will be output. Also in the case where, for example, a turning point exists as the curve of Wb in FIG. 11 indicates, when the maximum value in the vertical axis is exceeded, the maximum value of Sw (=1.0) will be output. In other words, if there is a turning point and there exist two solutions of inverse function, then the solution of the smaller value of the two solutions will be output.

In this case, if the smallest value in the values of the inverse functions invfr (Sr), invfg (Sg), and invfb (Sb) is denoted by Sw_1, the above described conditional expressions (7) to (9) will be satisfied by selecting a W signal Sw smaller in value than Sw_1. In other words, if the conditional expression (10) shown below is satisfied, the signal level of each of pixel signals D4r, D4g, D4b, and D4w (Sw) after the RGB/RGBW conversion is positive value.

[Expression 3]

S_{w}≦S_{w}_{_{—}}₁=Min(invfᵣ(Sᵣ),invf_{g}(S_{g}),invf_{b}(S_{b})) (10)

In this case, in a pixel 20 which shows the highest luminance level in the pixels 20 of the liquid crystal display panel 2, the signal level of each of pixel signals D4r, D4g, D4b, and D4w after the RGB/RGBW conversion will also be near 1.0, which is the upper limit. Therefore, if the signal level of the pixel signal D4w (W signal Sw) is changed, the signal level will exceed upper limit, which means the W signal Sw will be uniquely determined and there is no degree of freedom in signal level. On the other hand, pixels 20, other than the pixel showing the highest luminance level in all of the pixels 20 of the liquid crystal display panel 2, have a degree of freedom in the signal level of W signal Sw, in a range of the condition (restriction) specified by the expression (10) and the restriction that the signal level of each pixel signals D4r, D4g, D4b, and D4w is 1.0, which is the upper limit of them, or lower. Therefore, in such pixels 20, in order to uniquely determine the signal level of the W signal Sw, another constraint condition may be required in addition to the expression (10).

In the other constraint condition, in this case, the signal level (signal amplitude) of each of pixel signals D4r, D4g, D4b, and D4w should be at the smallest level. Also in this constraint condition, in the sub-pixels 20R, 20G, 20B, and 20W in the pixel 20, display light is emitted in such a manner that there is no unevenness in luminance (in such a manner as to make luminance even) as far as possible, thereby advantageously making it possible to reduce graininess (graininess caused by sub-pixel structure) of the image when displayed in one color. In view of this, as will be described below, it can be desirable that an RGB/RGBW conversion processing be carried out in the RGB/RGBW conversion section 424 so that signal levels of pixel signals D4r, D4g, D4b, and D4w making up the video signal D4 are substantially equal to each other.

In this instance, when the signal level (signal amplitude) of each of pixel signals D4r, D4g, D4b, and D4w is at the lowest level, then the highest signal level in the signal levels of the pixel signals D4r, D4g, and D4b and the signal level of pixel signal D4w (W signal Sw) are equal to each other. If there is such a W signal Sw within the range below the Sw_1 described earlier, then that is the signal level of W signal which satisfies the other constraint condition.

In view of this, firstly, in the condition where each of the signal levels of the pixel signals D4r, D4g, and D4b and the signal level of the W signal Sw are equal to each other, the signal level of the W signal is evaluated. The solution in this case will be equal to the highest signal level in the pixel signals D4r, D4g, and D4b, so that the solution will be the one having the highest level in the above described solutions. This can be expressed by the following expressions (11) to (14). Next, in order to obtain these solutions in a simple way, functions Fr (Sw), Fg (Sw), and Fb (Sw) set by the following expressions (14) to (16) are provided. The signal level Sw_2 of W signal, which is evaluated by the following expression (17) using inverse functions invFr (Sw), invFg (Sw), and invFb (Sw) respectively corresponding to the functions Fr (Sw), Fg (Sw), and Fb (Sw), is the signal level of W signal which satisfies the other constraint condition. In other words, the highest value in the values of inverse functions invFr (Sw), invFg (Sw), and invFb (Sw) is the Sw_2. Here, when it is assumed that this Sw2 is the solution, a condition (Sw_2<Sw_1) that the signal level after the RGB/RGBW conversion has positive value may be required to be satisfied. However, in the case where Sw_2 is higher than Sw_1, in order to lower the signal level (signal amplitude) of each of pixel signals D4r, D4g, D4b, and D4w as much as possible, Sw_2 which makes one of the pixel signals D4r, D4g, and D4b into “0” will be selected. Therefore, the W signal Sw finally evaluated upon an RGB/RGBW conversion processing is expressed by the following expression (18). In other words, of Sw_1 and Sw_2, the signal level having the lower value (the lowest value) is W signal Sw.

[Expression 4]

Sᵣ−fᵣ(S_{w})=S_{w} (11)

S_{g}−f_{g}(S_{w})=S_{w} (12)

S_{b}−f_{b}(S_{w})=S_{w} (13)

Fᵣ(S_{w})=S_{w}+fᵣ(S_{w}). (14)

F_{g}(S_{w})=S_{w}+f_{g}(S_{w}). (15)

F_{b}(S_{w})=S_{w}+f_{b}(S_{w}). (16)

S_{w}_{_{—}}₂=Max(invFᵣ(Sᵣ),invF_{g}(S_{g}),invF_{b}(S_{b})). (17)

S_{w}=Min(S_{w}_{_{—}}₁,S_{w}_{_{—}}₂). (18)

### [Description of Blocks]

Now, based on the foregoing description, blocks in RGB/RBGW conversion section 424 will be described.

A LUT 61R is a LUT which corresponds to the above described inverse function invfr (Sr), and outputs a value (signal level) indicated by the inverse function invfr (Sr) in response to input of a pixel signal D3r (Sr). Likewise, a LUT 61G is a LUT which corresponds to the above described inverse function invfg (Sg), and outputs a value (signal level) indicated by the inverse function invfg (Sg) in response to input of a pixel signal D3g (Sg). Likewise, a LUT 61B is a LUT which corresponds to the above described inverse function invfb (Sb), and outputs a value (signal level) indicated by the inverse function invfb (Sb) in response to input of a pixel signal D3b (Sb).

A Min selection section 62 is a section in which an arithmetic processing corresponding to the above described expression (10) is carried out, and from values (signal levels) output from LUTs 61R, 61G, and 61B, the signal level having the lowest value is selected and output as Sw_1.

A LUT 63R is a LUT which corresponds to the above described inverse function invFr (Sr), and outputs a value (signal level) indicated by the inverse function invFr (Sr) in response to input of a pixel signal D3r (Sr). Likewise, a LUT 63G is a LUT which corresponds to the above described inverse function invFg (Sg), and outputs a value (signal level) indicated by the inverse function invFg (Sg) in response to input of a pixel signal D3g (Sg). Likewise, a LUT 63B is a LUT which corresponds to the above described inverse function invFb (Sb), and outputs a value (signal level) indicated by the inverse function invFb (Sb) in response to input of a pixel signal D3b (Sb).

A Max selection section 64 is a section in which an arithmetic processing corresponding to the above described expression (17) is carried out, and from values (signal levels) output from LUTs 63R, 63G, and 63B, the signal level having the highest value is selected and output as Sw_2.

A Min selection section 65 is a portion in which an arithmetic processing corresponding the above described expression (18) is carried out, and from Sw_1 and Sw_2, the signal level having the lowest value (lower value) is selected and output as Sw.

A LUT 66R is a LUT which corresponds to the above described function fr (Sw), and outputs a value (signal level) indicated by the function fr (Sw) in response to input of a W signal Sw. Likewise, a LUT 66G is a LUT which corresponds to the above described function fg (Sw), and outputs a value (signal level) indicated by the function fg (Sw) in response to input of a W signal Sw. Likewise, a LUT 66B is a LUT which corresponds to the above described function fb (Sw), and outputs a value (signal level) indicated by the function fb (Sw) in response to input of a W signal Sw.

A subtraction section 67R subtracts the output (fr (Sw)) of the LUT 66R from a pixel signal D3r (Sr), and thus a pixel signal D4r (=Sr−fr (Sw)) is generated. Likewise, a subtraction section 67G subtracts the output (fg (Sw)) of the LUT 66G from a pixel signal D3g (Sg), and thus a pixel signal D4g (=Sg−fg (Sw)) is generated. Likewise, a subtraction section 67B subtracts the output (fb (Sw)) of the LUT 66B from a pixel signal D3b (Sb), and thus a pixel signal D4b (=Sb−fb (Sw)) is generated.

### [Signal Level Limiting Processing]

Although not shown in FIG. 5, it is desirable to carry out a processing for limiting a signal level during the RGB/RGBW conversion processing in the RGB/RGBW conversion section 424 so that a signal level of pixel signals D4r, D4g, D4b, and D4w does not exceed a predetermined upper limit (e.g., 1.0). The reason for this is as follows.

In a liquid crystal display panel having a sub-pixel structure of four colors of R, G, B, and W, the total number of sub-pixels is four thirds times larger than that in a liquid crystal display panel having a sub-pixel structure of three colors of R, G, and B, and therefore aperture ratio of each sub-pixel of the sub-pixel structure of four colors is relatively small. Thus, when electricity of the back light is even, display luminance of each sub-pixel in the sub-pixel structure of four colors tends to be relatively lower than luminance of each sub-pixel in the sub-pixel structure of three colors.

For example, if a correction in which each of the pixel signals D4r, D4g, D4b, and D4w after the RGB/RGBW conversion processing is multiplied by a predetermined gain coefficient is carried out, the signal level (luminance level) thereof may be made higher. However, in this case, if a video signal having a value near the maximum value (V) is multiplied by the gain coefficient, for example, the video signal may exceed a predetermined upper limit (e.g., 1.0). If a configuration where signals which exceed the upper limit are all (evenly) set to the upper limit is adopted, then a gradation thereof will be lost (gradation thereof will be roughened), causing a discontinuity in luminance gradation.

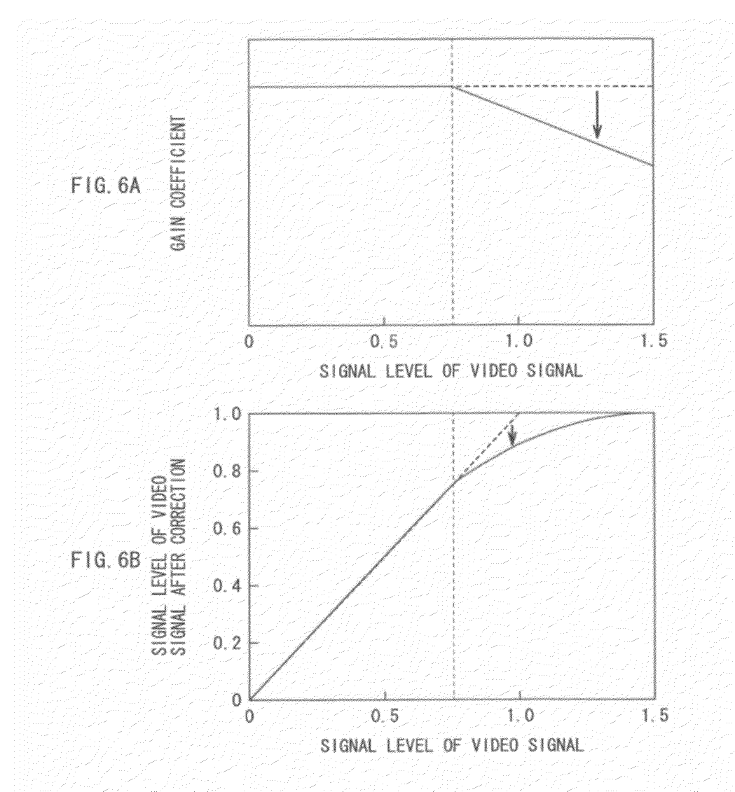

For the reasons described above, in the present embodiment, it is desirable to carried out the above-described limiting processing of signal level as follows. That is, for example, gain coefficient (shown in FIG. 6A) determined corresponding to the highest level in signal levels of video signals (pixel signals D4r, D4g, D4b, and D4w) is multiplied by each of the signals, thereby carrying out a correction (limiting processing) of signal levels. More specifically, when the signal level is above the threshold level, as shown by the arrow in the figure, the value of gain coefficient is gradually (here, linearly) decreased. Thus, as shown in FIG. 6B, for example, while the signal level of the video signal after the correction is made higher than before the correction, the signal level can be prevented from exceeding a predetermined upper limit (here, 1.0). In other words, by gradually decreasing the value of the gain coefficient according to the signal level, the increase rate of the signal level of the video signal after correction is gradually decreased, as shown by the arrow in the figure, and the upper limit can be reached exactly when the signal level before correction reaches the maximum value (here, 1.5). As a result, while avoiding the above described discontinuity in luminance gradation, the relative lowering of the display luminance due to the use of the sub-pixel structure of four colors of R, G, B, and W can be reduced.

It is to be noted that, technically, due to nonlinearity described later (nonlinearity in the relationship between the signal level of Sw and the signal levels of Wr, Wg, and Wb) as shown in FIG. 11, the multiplication of gain coefficient according to the present embodiment causes a change in chromaticity point. However, if the change is minute, there is no problem for practical use. In addition, if the upper limit on the output value of the above described LUTs 66R, 66G, and 66B is set to 1.0, the pixel signal D4w (W signal Sw) can be prevented from exceeding the upper limit of 1.0, so that it is also possible to carry out the above described signal level limiting processing only on the pixel signals D4r, D4g, and D4b.

### [B: Expression for Computation in BL Level Calculation Section 421]

Next, expressions for computing a signal level of lighting signal BL1 in the above described BL level calculation section 421 are specifically described. In the present embodiment, the case where the BL level calculation section is realized by a circuit configuration as an example is described below.

If a relationship between a signal level of Sw (described later) and signal levels of Wr, Wg and Wb supposedly shows linearity (proportional relationship), not nonlinearity as shown in FIG. 11, for example, a video signal after RGB/RGBW conversion also shows nonlinearity. In that case, if the signal level is multiplied by constant after the signal level is converted to video signals corresponding to four colors of R, G, B, and W, chromaticity point will not be changed. For this reason, in that case, by carrying out an RGB/RGBW conversion in which the minimum signal level (signal amplitude) is given after the RGB/RGBW conversion, and dividing the upper limit (1.0) of the signal level by the minimum signal level, the signal level of the lighting signal BL1 can be obtained. However, in the present embodiment, as described before, the relationship between the signal level of Sw and the signal levels of Wr, Wg, and Wb shows, for example, nonlinearity as shown in FIG. 11. Therefore, in the present embodiment, the above described method is not usable in the case where the signal level of the lighting signal BL1 is to be computed.

In view of this, as described below, a method may be adopted in which a solution of expression is obtained so that the maximum value of a video signal D4 obtained through an RGB/RGBW conversion after the a video signal D3 output from the chromaticity point adjustment section 423 is multiplied by constant (k fold) is 1.0. Hereinafter, this method is described in four cases. It is to be noted that, in the description below, three colors composing the video signal are denoted as c1, c2, and c3, each of which corresponds to any of R, G, and B.

(1) A case where any of pixel signals of D4r, D4g, and D4b obtained after an RGB/RGBW conversion is 1, and any of the other is 0.

In this case, as in the expressions (7) to (9), a solution can be obtained from a condition that all the pixel signals D4r, D4g, D4b, and D4w after an RGB/RGBW conversion have positive value. On the other hand, the pixel signal corresponding to one of the rest of the three colors c1 to c3 is a value within the range from 0 to 1, so that the following expressions (19) to (21) can be obtained. Of the expressions (19) to (21), with use of the expressions (19) and (20), the following expression (22) can be obtained. To solve the expression (22), firstly, function G_{c1,c2}(Sw) specified by the following expression (23) is defined. Subsequently, with respect to all combinations of colors, inverse function G⁻¹_{c1,c2}(Sc1/Sc2) corresponding to function G_{c1,c2}(Sw) specified by the following expression (24) is obtained to prepare a Look-Up Table. Then, in the case where a value having the ratio of (Sc1/Sc2) exists within an input range in a Look-Up Table corresponding to the inverse function G⁻¹_{c1,c2}(Sc1/Sc2), a W signal Sw and a multiplying factor k are obtained with use of the following expression (25). If the W signal Sw and the multiplying factor k thus obtained satisfy the above described expression (21), then the multiplying factor k is the maximum multiplying factor in question.

$$\begin{matrix}[ Expression 5 ] & \\ k \cdot {S}_{c 1} - {f}_{c 1} ( {S}_{w} ) = 0 & ( 19 ) \\ k \cdot {S}_{c 2} - {f}_{c 2} ( {S}_{w} ) = 1 & ( 20 ) \\ 0 \leq \{ k \cdot {S}_{c 3} - {f}_{c 3} ( {S}_{w} ) \} \leq 1 & ( 21 ) \\ \frac{{S}_{c 1}}{{S}_{c 2}} = \frac{{f}_{c 1} ( {S}_{w} )}{{f}_{c 2} ( {S}_{w} ) + 1} & ( 22 ) \\ {G}_{c 1 \cdot c 2} ( Sw ) = \frac{{f}_{c 1} ( {S}_{w} )}{{f}_{c 2} ( {S}_{w} ) + 1} & ( 23 ) \\ {S}_{w} = {G}_{c 1 , c 2}^{- 1} ( \frac{{S}_{c 1}}{{S}_{c 2}} ) & ( 24 ) \\ k = \frac{{f}_{c} ( {S}_{w} )}{{S}_{c}} = \frac{{f}_{c 1} ( {S}_{w} ) + 1}{{S}_{c 1}} & ( 25 )\end{matrix}$$

(2) A case where each of a pixel signal D4w and one of pixel signals D4r, D4g, and D4b are 1.

In this case, a D4w is 1, a pixel signal corresponding to one color of the c1 to c3 is 1, and pixel signals corresponding to remaining two colors are at a value in the range from 0 to 1. Therefore, the following expressions (26) to (28) can be obtained. If there exist a multiplying factor k satisfying the expressions (26) to (28), the multiplying factor k is the maximum multiplying factor in question, and can be expressed by the following expression (29).

$$\begin{matrix}[ Expression 6 ] & \\ k \cdot {S}_{c 1} - {f}_{c 1} ( 1 ) = 1 & ( 26 ) \\ 0 \leq \{ k \cdot {S}_{c 2} - {f}_{c 2} ( 1 ) \} \leq 1 & ( 27 ) \\ 0 \leq \{ k \cdot {S}_{c 3} - {f}_{c 3} ( 1 ) \} \leq 1 & ( 28 ) \\ k = \frac{{f}_{c 1} ( 1 ) + 1}{{S}_{c 1}} & ( 29 )\end{matrix}$$

(3) A case where, in the relationship between a signal level Sw (described later) and signal levels of Wr, Wg, and Wb, a characteristic line of Wb corresponding to B is a curve which has a peak value as shown in FIG. 11, for example.

Firstly, a value of a W signal Sw indicating a peak value is expressed as Sw_p. In this case, there is a possibility that in the case where a pixel signal D4b corresponding to B after a RGB/RGBW conversion is 1 and a W signal Sw (D4w) is Sw_p, a value V of a video signal D3 before a RGB/RGBW conversion is higher than that in the case where a W signal Sw is 1. In this case, each of pixel signals D4r and D4g other than the pixel signal D4b only needs to be a value within the range from 0 to 1, so that expressions (30) to (32) can be obtained. If there exists a multiplying factor k which satisfies these expressions (30) to (32), the multiplying factor k is the maximum multiplying factor in question, and can be expressed by the following expression (33).

$$\begin{matrix}[ Expression 7 ] & \\ k \cdot {S}_{b} - {f}_{b} ( {S}_{w \_ p} ) = 1 & ( 30 ) \\ 0 \leq \{ k \cdot {S}_{r} - {f}_{r} ( {S}_{w \_ p} ) \} \leq 1 & ( 31 ) \\ 0 \leq \{ k \cdot {S}_{g} - {f}_{g} ( {S}_{w \_ p} ) \} \leq 1 & ( 32 ) \\ k = \frac{{f}_{b} ( {S}_{w \_ p} ) + 1}{{S}_{b}} & ( 33 )\end{matrix}$$

(4) A case where a value of the W signal Sw in question exists between the above described value Sw_p of the W signal Sw and 1.

In this case, if colors c1 to c3 are expressed as c, the following expression (34) is obtained with regard to the color c, and the expression (34) can be transformed into the following expressions (35) and (36).

$$\begin{matrix}[ Expression 8 ] & \\ 0 \leq \{ k \cdot {S}_{c} - {f}_{c} ( {S}_{w} ) \} \leq 1 & ( 34 ) \\ \frac{{f}_{c} ( {S}_{w} )}{{S}_{c}} \leq k … & ( 35 ) \\ k \leq \frac{1 + {f}_{c} ( {S}_{w} )}{{S}_{c}} … & ( 36 )\end{matrix}$$

Of the multiplying factors k which satisfy these expressions with respect to all three colors of c1 to c3, the factor k having the highest value is the multiplying factor k in question. In this case, if the function fc (Sw) with respect to B has peak value, the right-hand value in the expression (36) monotonically decreases in the range larger than the value Sw_p of the W signal Sw at peak value. In this case, the multiplying factor k should be lower than the right-hand value in the expression (36) with respect to all the colors of c1 to c3; therefore, in the range where the right-hand value in the expression (36) has larger value, a point where the multiplying factor k gives the maximum value is as follows. That is, the maximum value is given at the intersection between the right-hand value in the expression (36) with respect to B and the right-hand value in the expression (36) with respect to the other color. In other words, where c1 and c2 are either of R or G, the following expressions (37) to (39) are obtained. Of these expressions, if the expressions (37) and (38) are transformed, the following expression (40) can be obtained. To solve this expression (40), as in the case of the above described (1), firstly, function H_{c1,b} (Sw) specified by the following expression (41) is defined. Thereafter, with respect to all the combinations of the colors, inverse function H⁻¹_{c1,b}(Sc1/S

b) of function H_{c1,b}(Sw) specified by the following expression (42) is obtained to prepare a Look-Up Table. If a value having the ratio of (Scl/Sb) exists within an input range in a Look-Up Table corresponding to the inverse function H⁻¹_{c1,b}(Sc1/Sb), the W signal Sw and the multiplying factor k can be evaluated with use of the following expression (43).

$$\begin{matrix}[ Expression 9 ] & \\ k \cdot {S}_{b} - {f}_{b} ( {S}_{w} ) = 1 & ( 37 ) \\ k \cdot {S}_{c 1} - {f}_{c 1} ( {S}_{w} ) = 1 ( {S}_{w \_ p} < {S}_{w} < 1 ) & ( 38 ) \\ 0 \leq \{ k \cdot {S}_{c 2} - {f}_{c 2} ( {S}_{w} ) \} \leq 1 & ( 39 ) \\ \frac{{S}_{c 1}}{{S}_{b}} = \frac{1 + {f}_{c 1} ( {S}_{w} )}{1 + {f}_{b} ( {S}_{w} )} & ( 40 ) \\ Hc 1 , b ( Sw ) = \frac{1 + fc 1 ( Sw )}{1 + fb ( Sw )} & ( 41 ) \\ {S}_{w} = {H}_{c 1 , b}^{- 1} ( \frac{{S}_{c 1}}{{S}_{b}} ) & ( 42 ) \\ k = \frac{{f}_{b} ( {S}_{w} ) + 1}{{S}_{b}} & ( 43 )\end{matrix}$$

Through consideration of all the cases in (1) to (4), the multiplying factor k can be evaluated, and the value V which is evaluated by multiplying the multiplying factor k by a video signal D3 before a RGB/RGBW conversion is the maximum value in that case.

### [Function and Effect of Liquid Crystal Display Apparatus 1]

Now, functions and effects of the liquid crystal display apparatus 1 of the present embodiment will be described.

### [1. Overview of Display Operation]

As shown in FIG. 1, in the liquid crystal display apparatus 1, firstly, the video signal processing section 41 carries out a predetermined image processing on the input video signal Din, thereby generating a video signal D1 (D1r, D1g, and D1b). Subsequently, the output signal generation section 42 carries out a predetermined signal processing on the video signal D1. Thus, a lighting signal BL1 in the back light 3 and a video signal D4 (D4r, D4g, D4b, and D4z) in the liquid crystal display panel 2 are generated.

Then, the video signal D4 and the lighting signal BL1 thus generated are input to the timing control section 43. Of them, the video signal D4 is supplied from the timing control section 43 to the data driver 51. The data driver 51 converts the video signal D4 from digital to analog so as to generate a video voltage serving as analog signal. Then, by the drive voltage output from the gate driver 52 and the data driver 51 to the pixel 20 (each of the sub-pixels 20R, 20G, 20B, and 20W), the display drive operation is carried out. By this, the display drive based on the video signal D4 (D4r, D4g, D4b, and D4w) is carried out to the pixel 20 (each of the sub-pixels 20R, 20G, 20B, and 20W) in the liquid crystal display panel 2.

Specifically, as shown in FIG. 3, in response to a select signal supplied through the gate line G from the gate driver 52, an On/OFF operation for the TFT device 21 is carried out. In this way, the data line D, the liquid crystal device 22 and the subsidiary capacitive device 23 are selectively connected. As a result, a video voltage based on the video signal D4 supplied from the data driver 51 is supplied to the liquid crystal device 22, and a line-sequential display drive operation is carried out.

Meanwhile, the lighting signal BL1 is supplied from the timing control section 43 to the back light driving section 50. The back light driving section 50 carries out, based on the lighting signal BL1, a lighting drive (lighting drive) for each light source (each light emitting device) in the back light 3. Specifically, a lighting drive (active control of luminance (dynamic control)) is carried out according to a luminance level (signal level) of an input video signal Din.

In this case, in the pixel 20 (sub-pixels 20R, 20G, 20B, and 20W) which has been supplied with the video voltage, an illuminating light from the back light 3 is modulated in the liquid crystal display panel 2 and then output as display light. Thus, the video display based on input video signal Din is carried out in the liquid crystal display apparatus 1.

In this case, in the present embodiment, the video display is carried out with use of video signals corresponding to the sub-pixels 20R, 20G, 20B, and 20W of four colors. Therefore, in comparison with the known apparatus in which a video display is carried out with use of video signals corresponding to sub-pixels of three colors of R, G, and B, enhanced luminance efficiency can be achieved. In addition, since an active drive of the back light 3 is carried out with use of luminance according to the luminance level of the input video signal Din, lower power consumption and expansion of dynamic range can be realized while keeping a display luminance.

### [2. Operation in Characteristic Part]

Next, as one of characteristic part of the present disclosure, an operation for generating an output signal (operation in the output signal generation section 42) in the case of using a sub-pixel structure of four colors of R, G, B, and W is specifically described in comparison with comparative example.

### Comparative Example

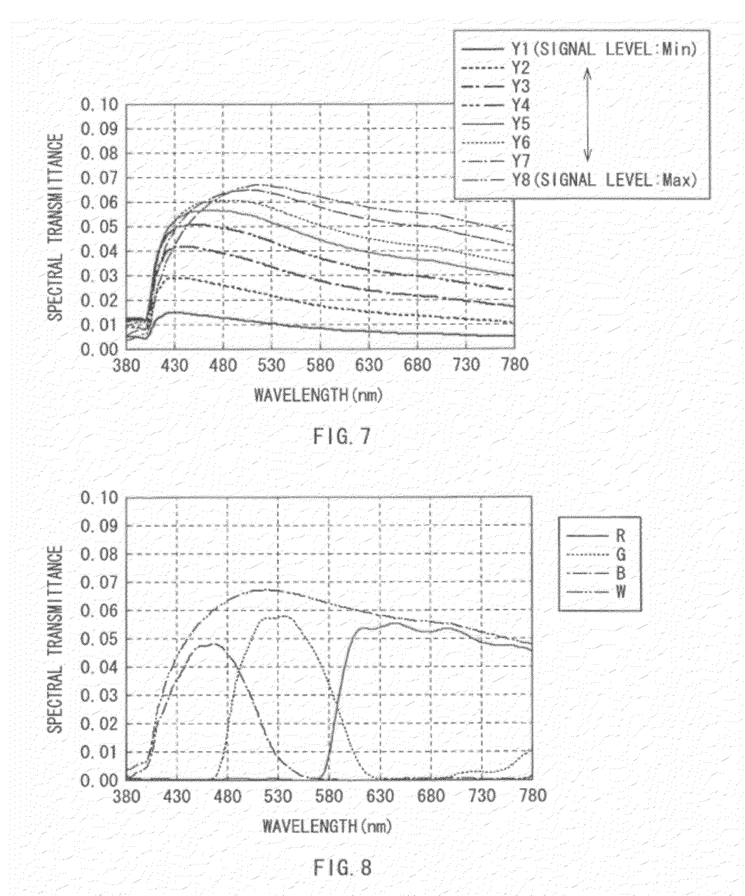

In a general liquid crystal display apparatus, incident light on a liquid crystal layer from a back light is modulated according to a signal level of a video signal, and amount of light (luminance) of transmitted light (display light) is controlled. Spectroscopic characteristic of transmitted light from the liquid crystal layer indicates gradation dependency, and as the signal level of the video signal lowers, a transmittance peak shifts to the short wavelength side (blue color light side) (see FIG. 7, for example). In this connection, in an liquid crystal display apparatus using sub-pixel structure of four colors of R, G, B, and Z (W), a sub-pixel of Z (W) shows a high luminance characteristic, so that spectroscopic characteristic of the transmitted light from the sub-pixel of Z (W) changes according to a signal level of a video signal. This means that a chromaticity point of transmitted light (display light) from whole pixel is also largely shifted depending on a signal level of a video signal. In particular, as in the present embodiment, if a sub-pixel of W (sub-pixel 20W) is adopted as a sub-pixel of Z, since no color filter is disposed in the sub-pixel of W, variation in chromaticity point of a display light which occurs according to the signal level, as described above, is large.

For example, if cell thickness or drive voltage in a sub-pixel of W is set (see FIG. 8, for example) so that transmittance in sub-pixel of W indicates relatively high liquid crystal spectroscopic characteristic, in other words, that transmittance peak is located near the wavelength region of G, the result is as follows. That is, as shown in FIG. 7 for example, in a signal level lower than the maximum signal level in the sub-pixel of W, a transmittance peak is located in a wavelength region of B. It is to be noted that, FIG. 8 illustrates spectroscopic transmittance in each of sub-pixels R, G, B, and W.

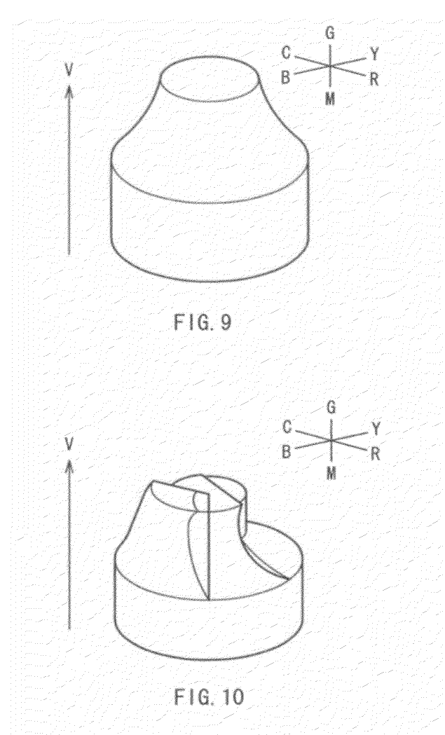

If color reproduction characteristic in a sub-pixel structure of four colors of R, G, B, and W is illustrated in HSV color space, if it is assumed that there is no variation in transmittance peak in sub-pixel of W, the result is ideally as shown in FIG. 9, for example. In other words, shown in FIG. 9 is a rotationally symmetric color space with the white-color chromaticity point as the center. However, practically, variation in transmittance peak in a sub-pixel of W depending on a signal level occurs as mentioned before, and therefore color reproduction characteristic in the sub-pixel structure of four colors of R, G, B, and W according to comparative example (known) will be as shown in FIG. 10, for example. In other words, a bright (value of value V is high) region exists in colors (color phase) from white (W) to blue (B) side, while dark (value of value V is low) region exists in color region (color phase) from magenta (M) to cyan (C) with yellow (Y) at the center thereof. Incidentally, the higher the value of value V at this time, the more reduction in power consumption can be realized.

As described, in the liquid crystal display apparatus using a sub-pixel structure of four colors of R, G, B, and Z according to the comparative example, due to a variation in spectroscopic characteristic of transmitted light from sub-pixel of Z, variation (color shift) in chromaticity point of the display light is caused according to a signal level of a video signal, thereby lowering image quality. In addition, in the case where an active control of back light luminance is simultaneously used, advantages such as lower power consumption and expansion of dynamic range may not be sufficiently achieved.

FIG. 11 illustrates an exemplary relationship between a signal level of a W-sub-pixel video signal (signal level of W signal) and, above described Wr, Wg, and Wb (signal level of each of R-, G-, and B-sub-pixel intermediate video signals in the case where a signal level of W signal is replaced by a set of the R-, G-, and B-sub pixel intermediate video signals) in the sub-pixel structure of four colors of R, G, B, and W according to the comparative example. If it is assumed that there is no variation in transmittance peak in the sub-pixel of W as in the case shown in FIG. 9, for example, the relationship between the signal level of W signal and Wr, Wg, and Wb will be proportional (will show linearity). In the comparative example, as described above, variation in transmittance peak in a sub-pixel of W is caused according to a signal level, each of Wr, Wg, and Wb is a function having a gradient depending on a signal level of W signal (shows nonlinearity).

If an active control (dimming processing) of back light luminance is carried out in the case where such a nonlinearity is shown, a signal level of the video signal is also nonlinearly changed to cause a variation (color shift) in chromaticity point in some cases, thereby lowering image quality. Further, in order to reduce such a lowering of image quality due to the color shift, a complicated arithmetic processing for the nonlinearity becomes necessary during a signal processing (dimming processing), which results in a complicated device configuration. Specifically, as opposed to the present embodiment described below, for example, in the case where generation of a lighting signal and a dimming processing are carried out after video signals of R, G, B, and W are generated by an RGB/RGBW conversion processing, it is difficult to realize, in a simple configuration, both the dimming processing and the prevention of lowering of image quality caused by the color shift.

### Embodiment

In the embodiment, signal processing are carried out in the output signal generation section 42 as follows. Specifically, firstly, the BL level calculation section 421 generates a lighting signal BL1 based on a video signal D1, and then, the LCD level calculation section 422 carries out a predetermined dimming processing (division operation) based on the video signal D1 and the lighting signal BL1 to generate a video signal D2. The RGB/RGBW conversion section 424 carries out a RGB/RGBW conversion processing on a video signal D3 based on the resultant video signal D2 from the dimming processing to generate a video signal D4. In other words, the generation and dimming processing of the lighting signal BL1 are carried out on the video signal D1 (D1r, D1g, and D1b) corresponding to the three colors of R, G, and B, and thereafter, the RGB/RGBW conversion processing is carried out to generate the video signal D4 corresponding to four colors of R, G, B, and W.

By this procedure, as described above, as opposed to the case where the generation and dimming processing of the lighting signal are carried out after video signals of R, G, B, and W are generated by the RGB/RGBW conversion processing, the result is as follows. That is, the color shift of the display light due to variation of peak wavelength region (above-described nonlinearity) in emitted light (transmitted light) from the sub-pixel 20W is suppressed with a simple arithmetic processing (dimming processing).

In addition, in the embodiment, the chromaticity point adjustment section 423 in the output signal generation section 42 carries out a predetermined chromaticity point adjustment on the video signal D2 (D2r, D2g, and D2b) to generate a video signal D3 (D3r, D3g, and D3b). More specifically, when the video signal D2 (D1) is a video signal which indicates W, the chromaticity point adjustment is carried out so that the chromaticity point of display light emitted from the liquid crystal display panel 2 based on the emitted light from the back light 3 is a white-color chromaticity point. Subsequently, the RGB/RGBW conversion section 424 carries out the RGB/RGBW conversion processing for the video signal D3 (D3r, D3g, and D3b) after the chromaticity point adjustment in order to generate the video signal D4 (D4r, D4g, D4b, and D4w) which corresponds to four colors of R, G, B, and W.

In this case, the chromaticity point adjustment section 423 carries out the chromaticity point adjustment, by using, for example, the transformation matrix M_{d2}→_{d3} specified by the expression (4). In other words, the video signal D2 (pixel signals D2r, D2g, and D2b) is multiplied by the transformation matrix M_{d2}→_{d3} (or, matrix operation is carried out), thereby to generate the video signal D3 (pixel signals D3r, D3g, and D3b).

By this, when the video signal D2 is a video signal which indicates W, the chromaticity point of the display light indicates a white-color chromaticity point. In other words, the chromaticity point of the peak wavelength region in emitted light from the sub-pixel 20W is adjusted, and the color shift of the display light is suppressed.

Further, in the embodiment, upon the RGB/RGBW conversion processing, the LUTs 66R, 66G, and 66B provided in advance according to, for example, the nonlinearity shown in FIG. 11 (nonlinearity in the relationship between a signal level of Sw and signal levels of Wr, Wg, and Wb) are used. Thus, fine adjustment of the RGB/RGBW conversion processing according to a characteristic (e.g., the above described nonlinearity) of the liquid crystal display apparatus 1 (liquid crystal display panel 2) becomes possible.

As described, in the embodiment, in the output signal generation section 42, the lighting signal BL1 is generated based on the video signal D1 corresponding to three colors of R, G, and B and the predetermined dimming processing based on the video signal D1 and the lighting signal BL1 is carried out, and thereafter, the predetermined RGB/RGBW conversion processing based on the video signal D2 after the dimming processing is carried out, thereby to generate the video signal D4 corresponding to four colors of R, G, B, and W. Consequently, it is possible to reduce the color shift of the display light caused by the nonlinearity with a simple arithmetic processing (dimming processing). Therefore, in the case where a video display is carried out using the sub-pixel structure of four colors of R, G, B, and W, the dimming processing can be realized in a simple configuration with the lowering of image quality due to color shift being suppressed.

In addition, since the pixel 20 of the embodiment is configured to include the sub-pixel 20W corresponding to W as an example of a sub-pixel 20Z which will be described later, it is not necessary to provide any color filter in this sub-pixel 20W, and therefore enhanced efficiency in luminance (lower power consumption) can be realized in particular.

### MODIFICATION

Next, modifications (modifications 1 to 3) of the embodiment will be described. It is to be noted that the same components as those of the embodiment will be represented by the same symbols and the descriptions thereof are omitted as appropriate.

### Modification 1

In a liquid crystal display apparatus according to a modification 1, the BL level calculation section 421 in the liquid crystal display apparatus 1 of the embodiment uses a common LUT shared by R, G, and B hereinafter described (common LUT 70 described later). Specifically, when generating a lighting signal BL1, as opposed to the embodiment, the BL level calculation section 421 uses a LUT (second Look-Up Table) in which a relationship between chromaticity of the video signal D1 and the highest signal level which can be expressed in the chromaticity or the inverse of the signal level is specified in advance.

The reason for this is as follows. That is, although the highest signal level (signal amplitude) which can be expressed can be obtained by using the circuit configuration as in the embodiment, the configuration (circuit configuration) may be complicated. In view of this, in the modification 1, the highest signal level which can be expressed for chromaticity of the video signal D1 is calculated in advance, and the resulting level is retained as a LUT for the video signal D1. In this manner, through comparison with the signal level of the video signal D1, the lighting signal BL1 can be calculated. Methods for preliminarily calculating the highest signal level which can be expressed for the chromaticity of the video signal D1 are described below.

Firstly, as the first method, the highest signal level which can be expressed may be obtained with use of the methods for obtaining solutions in each of the cases (1) to (4) explained in the above described embodiment.

Next, as the second method, a video signal D1 before an RGB/RGBW conversion may be obtained through a back calculation of a video signal D4 after the RGB/RGBW conversion. In the signal which becomes the highest value after the RGB/RGBW conversion, a pixel signal corresponding to either of colors of R, G, or B is 1 as the upper limit. For this reason, a reverse conversion (RGBW/RGB conversion) of a video signal in which a pixel signal corresponding to either of colors is made to be 1 and at the same time the other pixel signals corresponding to the other colors are minutely changed is carried out to thereby generate a video signal D3, and through inverse matrix calculation, or the like, of the video signal D3, the video signal D1 is obtained. The video signal D1 obtained in this way is divided by chromaticity, and the signal having amplitude of the largest value V in the chromaticity is obtained as the highest signal.

As the third method, a repeated computation may be adopted and the computation method is as follows. Firstly, an arbitrary video signal D1 is multiplied by constant until its signal level (amplitude) is, for example, almost 2, and then, a matrix conversion, and an RGB/RGBW conversion which gives the minimum amplitude are carried out. At this point of time, a W signal Sw is converted up to 1 as the upper limit of LUT while pixel signals corresponding to R, G, and B exceed 1. Here, in the pixel signals corresponding to these R, G, and B, a difference value between upper limit and 1 is denoted by d whereas the signal level (amplitude) of the video signal D1 is denoted by h. Subsequently, assuming that the next input signal is a signal wherein the video signal D1 is multiplied by (h−d)/h, again the matrix operation and the RGB/RGBW conversion are carried out to evaluate the difference value d between the upper limit and 1. This computation is repeatedly carried out until the difference value d becomes below a predetermined threshold level (minute value), and amplitude of value V of the input signal at that time is used as the highest expressible signal level.

Meanwhile, there may be various methods for using the highest expressible signal value obtained in this way as LUT.

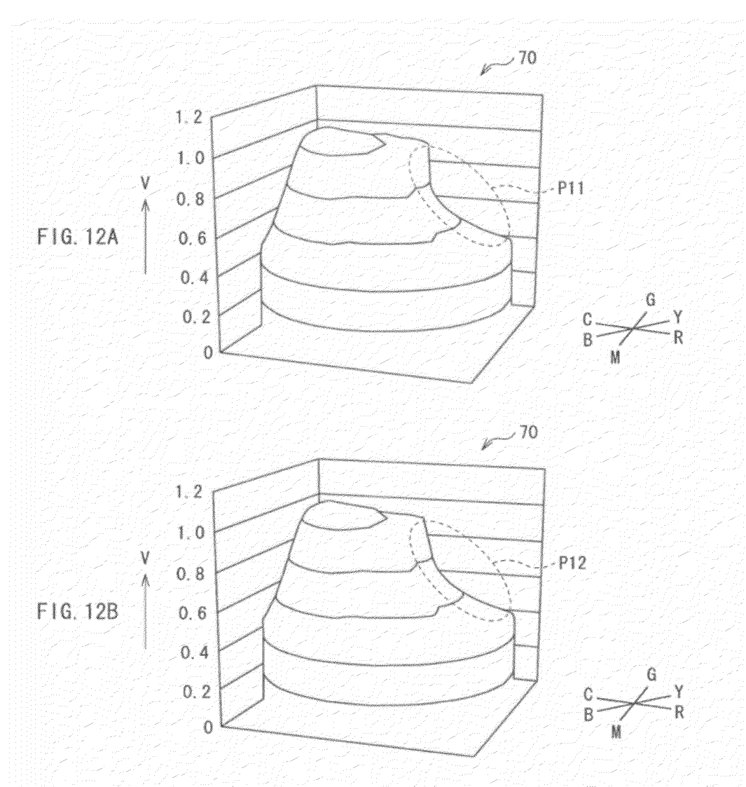

For example, a LUT of HSV type, as the common LUT 70 shown in FIGS. 12A and 12B, can be given as an example. The common LUT 70 is a LUT in which hue H and saturation S in chromaticity of the video signal D1 are obtained, and the highest expressible signal level for those is used as value V. In the modification 1, the lighting signal BL1 can be obtained with use of the highest value (the highest value in all pixels 20) of the ratio which can be obtained by dividing the video signal D1 by the highest expressible signal level (value V) which is obtained from the common LUT 70.

Depending on chromaticity of the video signal D1, there is a portion (region) where the maximum value of the value V is steeply changed in the common LUT 70, as shown by the symbol P11 in FIG. 12A, for example. In the region where the maximum value of the value V is steeply changed, the display luminance can also be rapidly changed for the reason described below.

That is, generally, when rapidly changed, luminance of the back light causes bouncing (color skipping) and other problems, so that luminance of the back light is changed with a certain amount of time constant. For example, in the case where gradation of color is scrolled, when a portion where the maximum value of value V is steeply dropped reaches a boundary portion of the back light, the BL level calculation section 421 will tend to rapidly increase luminance of the back light. However, as described earlier, luminance of the back light changes only in a certain amount of time constraint, so that the luminance and chromaticity of the region will not be correctly expressed, thereby generating “dark” portion.

Therefore, in the common LUT 70 of the present modification, as shown by the symbol P12 in FIG. 12B, for example, it is preferred that the signal level variation in the lighting signal BL1 in response to chromaticity variation in the video signal D1 be limited to equal to or lower than a predetermined threshold level. As a reference for this predetermined threshold level, a value of sensitivity of the human eye (for example, ΔE<1.0) can be given. It is to be noted that, ΔE is color difference between two colors which is defined in CIE1976 L*u*v* color system and CIE1976 L*a*b* color system, and values around ΔE≈1 are the allowable tolerance of color difference.

In the case where the common LUT 70 is set in this manner, it is possible to reduce the rapid change in luminance, bouncing (color skipping), and the like which are caused by a steep change in luminance of the back light due to a shape of a color space.

### Modification 2

A liquid crystal display apparatus according to a modification 2 includes a BL calculation section 421A described below disposed in place of the BL level calculation section 421 in the liquid crystal display apparatus 1 of the above mentioned embodiment. As opposed to the BL level calculation section 421 described in the modification 1, the BL level calculation section 421A uses individual LUTs (LUTs 74R, 74G, and 74B described later) for each of pixel signals corresponding to R, G, and B.

The reason for this is as follows. That is, although all the video signals described above are linear signals, input signals (video signal D1) are typically signals which have been converted by gamma conversion (y conversion). Therefore, if gamma data can be processed as it is, simple configuration can be realized. In view of this, the BL level calculation section 421A of the modification 2 includes three kinds of LUTs each of which is used when each of pixel signals of R, G, and B is at the maximum value. In addition, as gamma data, the input signal is divided by the maximum value of R, G, and B, and chromaticity is specified by values other than the maximum value.

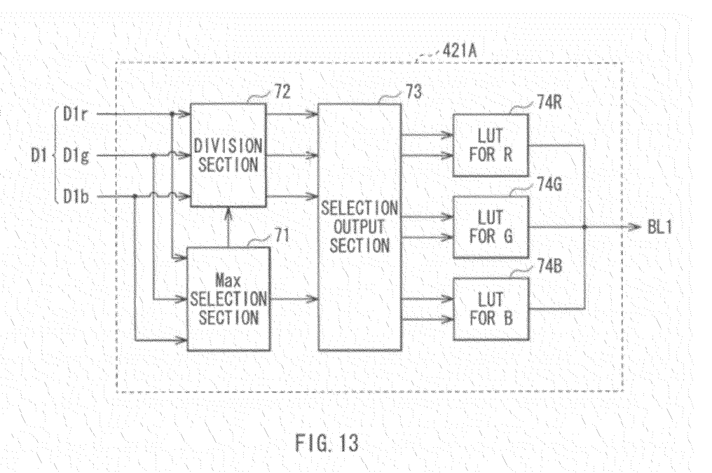

FIG. 13 illustrates an exemplary block configuration of the BL level calculation section 421A. The BL level calculation section 421A includes a Max selection section 71, a division section 72, a selection output section 73, and LUTs 74R, 74G, and 74B for each color of R, G, and B.

The Max selection section 71 selects a pixel signal which has the highest signal level from pixel signals D1r, D1g, and D1b in a video signal D1, and outputs the selected signal.

The division section 72 is a section in which each of pixel signals D1r, D1g, and D1b in a video signal D1 is divided by the highest signal level output from the Max selection section 71.

The selection output section 73 selects a part of the divided values of the pixel signals D1r, D1g, and D1b output from the division section 72, and outputs the selected part to each of LUTs 74R, 74G, and 74B. Specifically, the selection output section 73 outputs the divided values of the pixel signals D1g and D1b individually to the LUT 74R, outputs the divided values of the pixel signals D1r and D1b individually to the LUT 74G, and outputs the divided values of the pixel signals D1r and D1g individually to the LUT 74B.

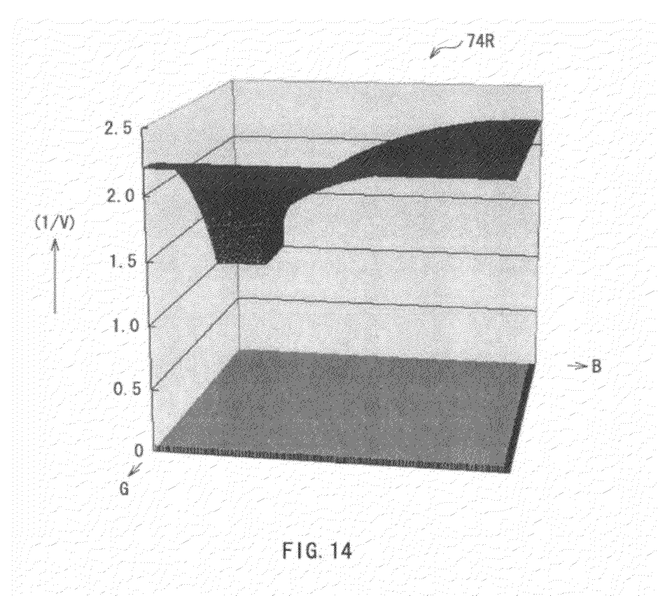

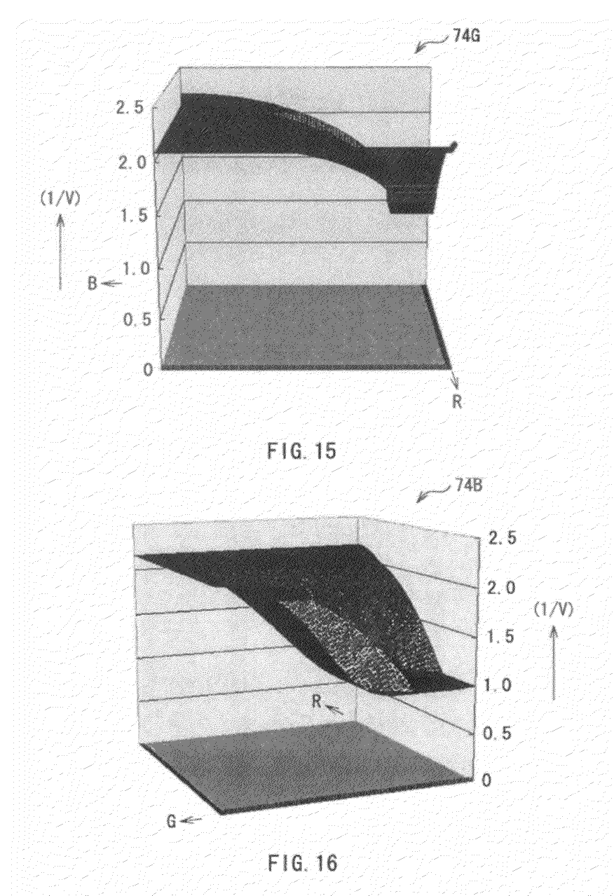

As shown in FIGS. 14 to 16, for example, the LUTs 74R, 74G, and 74B are LUTs in which hue H and saturation S in chromaticity of the video signal D1, and inverse of the corresponding highest expressible signal level (1/value V) are related. This is because, as mentioned above, the ratio obtained by dividing a pixel signal by the signal level having the highest expressible value is used when calculating back light luminance, so that the use of the inverse of value V leads to a simple configuration.

Here, also in the modification 2 as in the modification 1, it is preferred that, in the LUTs 74R, 74G, and 74B, signal level variation of the lighting signal BL1 responding to chromaticity variation in the video signal D1 be limited to equal to or lower than a predetermined threshold level.

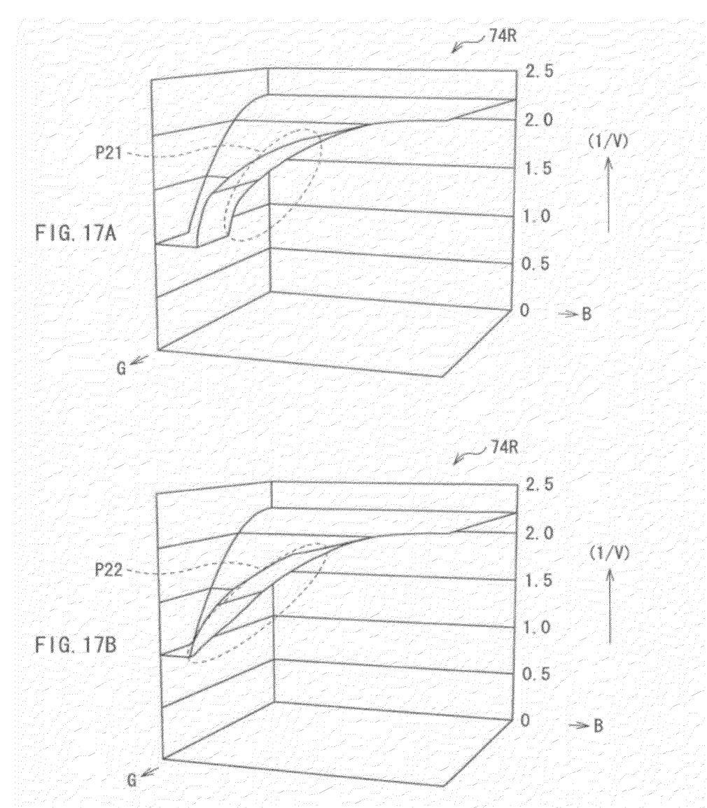

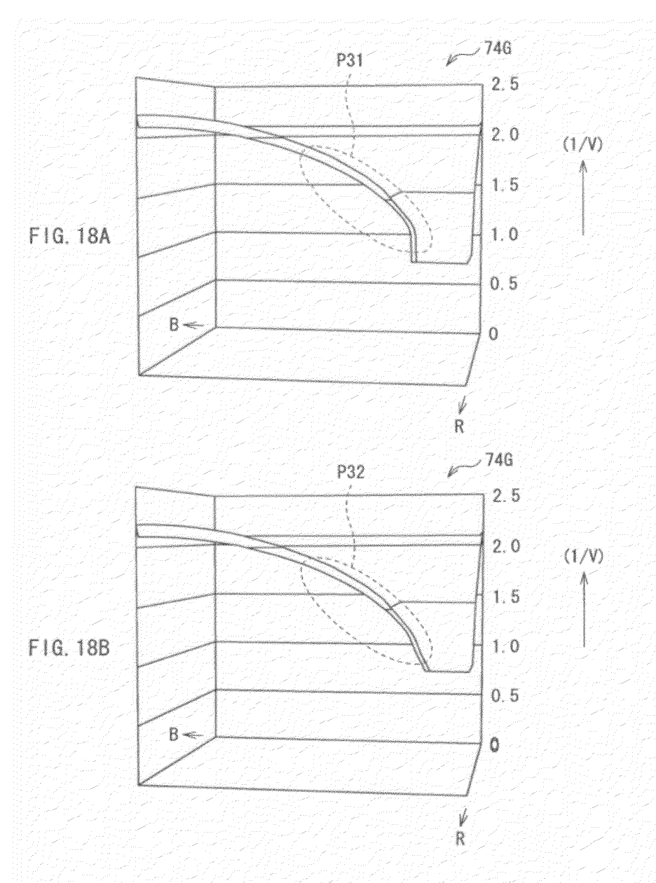

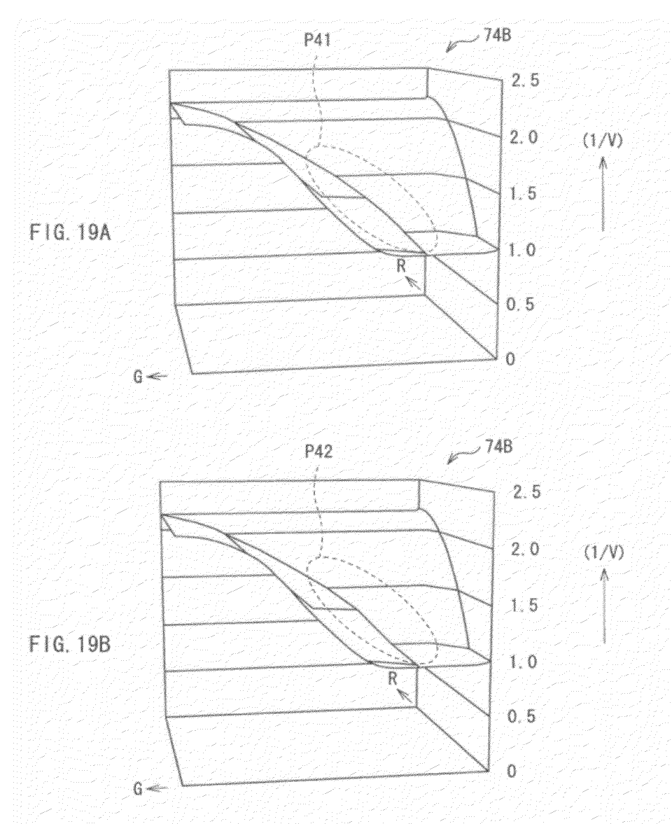

Specifically, in a portion (region) where (1/V) is steeply changed as shown by symbol P21 in FIG. 17A, for example, it is preferred that the signal level variation be limited (softened) to equal to or lower than the threshold level as shown by symbol P22 in FIG. 17B, for example. Likewise, portions (regions) shown, for example, by symbols P31 in FIGS. 18A and P41 in FIG. 19A are preferably limited in the signal level variation as shown, for example, by symbols P32 in FIGS. 18B and P42 in FIG. 19B.

### Modification 3

A liquid crystal display apparatus according to a modification 3 includes a liquid crystal display panel having a pixel 20-1 described below in place of the liquid crystal display panel 2 having the pixel 20 in the liquid crystal display apparatus 1 of the embodiment.

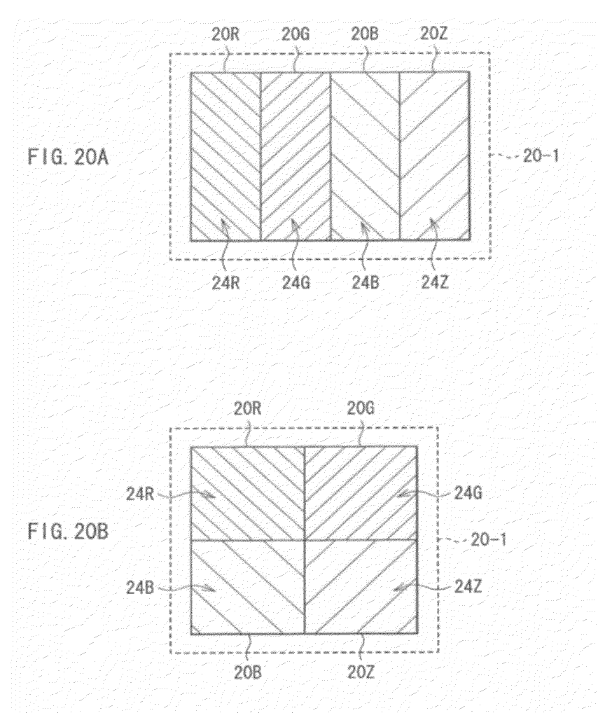

FIGS. 20A and 20B are schematic plan views illustrating exemplary configurations of sub-pixels of each pixel 20-1 according to the modification 3. FIGS. 20A and 20B correspond to FIGS. 2A and 2B, respectively.

Each pixel 20-1 includes the same sub-pixels 20R, 20G, and 20B corresponding to three colors of R, G, and B as in the embodiment, and a sub-pixel 20 Z which shows luminance higher than those of the three colors. The color (Z) which shows the high luminance includes yellow (Y), white (W), and the like, and, in the modification 3, the color (Z) is described as a broader concept of these exemplified colors.

Of these sub-pixels 20R, 20G, 20B, and 20Z of four colors of R, G, B, and Z, the sub-pixels 20R, 20G, and 20B corresponding to three colors of R, G, and B are provided with, as in the embodiment, the color filters 24R, 24G, and 24B corresponding to each color of R, G, and B, respectively. On the other hands, the sub-pixel 20Z of Z is provided with a color filter (color filter 24Z shown in the figure) corresponding to Y in the case of Z=Y, for example. It is to be noted that, as described in the embodiment, no color filter is provided in the sub-pixel 20Z (sub-pixel 20W) in the case of Z=W. In addition, also in the pixel 20-1 of the present modification 3, the layout of each of the sub-pixels 20R, 20G, 20B, and 20Z is not limited to these examples, and other layouts may be adopted.

Also in the liquid crystal display apparatus in the modification 3 configured in this manner, it is possible to obtain the same effects as in the liquid crystal display apparatus 1 of the embodiment, through the same functions. More specifically, in the case where a video display is performed with use of the sub-pixel structure of four colors of R, G, B, and Z, it is possible to realize in a simple configuration a dimming processing while suppressing lowering of image quality due to color shift.

### Other Modifications

Hereinbefore, the present disclosure has been described with the embodiment and the modifications, but the present disclosure is not limited to them, and various modifications may be made.

For example, in the embodiment and so forth, description has been made regarding the case where active control of the back light is carried out with entire screen targeted as a unit. However, for example, it is possible to adopt a configuration in which a screen is partitioned into a plurality of sub-regions and active control of the back light is individually carried out for each sub-region.

Further, the configurations of blocks and the computing methods described in the embodiment and so forth are not limited thereto, and other configurations and methods may be adopted.

Still further, in the embodiment and so forth, description has been made regarding the case where a sub-pixel structure of four colors of R, G, B, and Z is adopted. In addition thereto, the present disclosure may be applied to a sub-pixel structure of five colors or more colors which includes a sub-pixel (s) corresponding to other color (s).

In addition, the series of processing described in the embodiment and so forth may be carried out by hardware or software. When the series of processing are carried out by software, the program configuring the software is installed to the general-purpose computer or the like. The program may be stored in advance in the recording medium incorporated in the computer.

The present disclosure contains subject matter related to that disclosed in Japanese Priority Patent Application JP 2010-168579 filed in the Japan Patent Office on Jul. 27, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display apparatus comprising:
a light source section;
a liquid crystal display panel including a plurality of pixels each of which having sub-pixels of three colors of red (R), green (G), and blue (B), and a sub-pixel of a color (Z) showing luminance higher than those of the three colors, the liquid crystal display panel being configured to modulate light emitted from the light source section, based on input video signals corresponding to the respective three colors of R, G, and B to perform a video display; and
a display control section including an output signal generation section adapted to generate, based on the input video signals, output video signals corresponding to the respective four colors of R, G, B, and Z, and to generate a lighting signal of the light source section, the display control section being configured to perform a display drive on the sub-pixels of R, G, B, and Z in the liquid crystal display panel with use of the respective output video signals, and perform a lighting drive on the light source section with use of the lighting signal, wherein
the output signal generation section generates the lighting signal, based on the input video signals, to carry out a predetermined dimming processing, based on both the input video signals and the generated lighting signal, and
the output signal generation section generates the output video signals through carrying out, based on a resultant video signal from the dimming processing, a predetermined color conversion processing.

2. The liquid crystal display apparatus according to claim 1, wherein
the output signal generation section uses a first look-up table (LUT) when performing the color conversion processing, the LUT being provided in advance according to nonlinearity in a relationship between a signal level of a Z-sub-pixel video signal of the output video signals and a signal level of each of R-, G-, and B-sub-pixel intermediate video signals which are specified if an assumption is made that the signal level of the Z-sub-pixel video signal is replaced by a set of the R-, G-, and B-sub-pixel intermediate video signals.

3. The liquid crystal display apparatus according to claim 2, wherein
the output signal generation section carries out a predetermined chromaticity point adjustment on the resultant video signal from the dimming processing, to allow a chromaticity point of the display light emitted from the liquid crystal display panel to come to a white color chromaticity point when the input video signals are for white (W) color; and then
the output signal generation section generates the output video signal through carrying out the color conversion processing on a resultant video signal from the chromaticity point adjustment.

4. The liquid crystal display apparatus according to claim 1, wherein
the output signal generation section carries out the color conversion processing to allow the signal levels of the sub-pixel video signals configuring the output video signals to be substantially equal to one another.

5. The liquid crystal display apparatus according to claim 1, wherein
the output signal generation section limits, in the color conversion processing, each of the signal levels of the sub-pixel video signals configuring the output video signals to be equal to or less than a predetermined upper limit.

6. The liquid crystal display apparatus according to claim 1, wherein
the output signal generation section generates the lighting signal with use of a second look-up table (LUT) which specifies, in advance, a relationship between a chromaticity represented by the input video signals and the highest signal level expressible for the corresponding chromaticity or the inverse of the highest signal level.

7. The liquid crystal display apparatus according to claim 6, wherein
the second look-up table is configured to limits signal level variation in the lighting signal which is specified by a chromaticity variation in the input video signal to be equal to or lower than a predetermined threshold level.

8. The liquid crystal display apparatus according to claim 1, wherein
each of the pixels includes a sub-pixel of white (W) as the sub-pixel of Z.

9. The liquid crystal display apparatus according to claim 8, wherein
the sub-pixels of three colors are provided with color filters corresponding to respective colors of R, G, and B, whereas the sub-pixel of W is provided with no color filter.
